(19) United States
(12) Patent Application Publication
(10) Pub. No.: US 2024/0383521 A1
(43) Pub. Date: Nov. 21, 2024

(54) STEER-BY-WIRE STEERING DEVICE

(71) Applicant: HL MANDO CORPORATION, Gyeonggi-do (KR)

(72) Inventor: Hyunbi KWON, Gyeonggi-do (KR)

(21) Appl. No.: 18/628,712

(22) Filed: Apr. 6, 2024

(30) Foreign Application Priority Data
May 15, 2023 (KR) 10-2023-0062404

(51) Int. Cl. B62D 5/00

(52) U.S. Cl. CPC B62D 5/001

(57) ABSTRACT

A steer-by-wire steering device may comprise: a shaft interlocking member fixed to a steering shaft so that the shaft interlocking member is rotated together with the steering shaft; a rotation stopper member rotatably arranged around the steering shaft and extending in a radial direction of the steering shaft, the rotation stopper member configured to be rotatable together with the shaft interlocking member by being supported by an end portion of the shaft interlocking member according to rotation of the steering shaft; and a housing. The housing may have a stopper protrusion protruding from a surface of the housing to block rotation of the rotation stopper member, or an arc-shaped guide recess in which an end portion of the rotation stopper member is rotatably inserted wherein ends of the arc-shaped guide recess are configured to block rotation of the end portion of the rotation stopper member.

### CROSS-REFERENCE TO RELATED APPLICATION

This application claims priority to and benefit from Korean Patent Application No. 10-2023-0062404, filed on May 15, 2023, which is hereby incorporated by reference for all purposes as if fully set forth herein.

### BACKGROUND

### Field

The present disclosure may generally relate to a steer-by-wire steering device and, more specifically, to a steer-by-wire steering device configured to stop a steering wheel from further mechanical rotation over an allowable rotation range when the rotation of the steering wheel reaches a maximum point.

### Description of Related Art

In general, vehicle steering devices adopt power steering for assisting a driver in manipulating a steering wheel and providing steering convenience. The power steering may include hydraulic type steering using hydraulic power, electro-hydraulic type steering using both hydraulic power and motor power, and electric power type steering using only motor power.

Unlike the powering steering system, steer-by-wire (SBW) steering devices remove mechanical/physical linkages, such as universal joint or pinion shaft, between the steering wheel and front wheels. The SBW steering devices may use one or more motors to steer the vehicle.

However, such a steer-by-wire steering device has no mechanical connection between the steering shaft and the road wheels, thereby causing indefinite rotation of the driver's steering wheel, with the result of a poor steering feel and steering stability.

Therefore, a need arises for stopping the steering wheel from further rotating over an allowable rotation range, e.g., when the rotation of the steering wheel or the road wheels reach the maximum point (i.e. when the steering wheel or the road wheels are in full-turn state in conventional steering devices).

### BRIEF SUMMARY

Conceived in the foregoing background, some embodiments of the present disclosure may provide a steer-by-wire steering device that may enhance the driver's sense of steering and steering stability by stopping a steering wheel from further mechanical rotation over an allowable rotation range when the rotation of the steering wheel reaches a maximum point.

The objects of the present embodiments are not limited to the foregoing and other objects will be apparent to one of ordinary skill in the art from the following detailed description.

According to the present embodiments, there may be provided a steer-by-wire steering device comprising a shaft interlocking member coupled to a steering shaft to rotate in conjunction, a rotation stopper member rotatably coupled to the steering shaft to be supported on an end portion of the shaft interlocking member and rotate in conjunction with the shaft interlocking member when the steering shaft rotates, and a housing having a stopper protrusion where an end portion of the rotation stopper member is supported to restrict rotation of the steering shaft and the shaft interlocking member and the rotation stopper member when the steering shaft rotates.

Further, according to the present embodiments, the steer-by-wire steering device may further comprise an axial supporting member coupled to the steering shaft to axially support the shaft interlocking member and the rotation stopper member.

Further, according to the present embodiments, the shaft interlocking member may include a shaft coupling portion having a shaft hole to which the steering shaft is coupled and an extension supporting portion radially extending from a side of an outer circumferential surface of the shaft coupling portion to be supported by the rotation stopper member.

Further, according to the present embodiments, the rotation stopper member may include a main body having a coupling hole to which the steering shaft is coupled and a protrusion supporting portion radially extending from a side of an outer circumferential surface of the main body and axially protruding to support the extension supporting portion.

Further, according to the present embodiments, a damping member elastically supporting the extension supporting portion may be coupled to the protrusion supporting portion.

Further, according to the present embodiments, the steer-by-wire steering device may further comprise a stopper supporting member coupled between the coupling hole of the main body and an outer circumferential surface of the steering shaft to be axially supported by the shaft coupling portion.

Further, according to the present embodiments, the stopper supporting member may be formed as a ring with a cutout in a side thereof and may have an outer circumferential groove formed in an outer circumferential surface thereof to seat an inner surface of the coupling hole.

Further, according to the present embodiments, the stopper supporting member may have a circumferential groove circumferentially formed in an outer end portion, and have an outer supporting portion formed radially outside of the circumferential groove and an inner supporting portion formed radially inside of the circumferential groove.

Further, according to the present embodiments, the inner supporting portion may have a cutout from an outer end of the inner supporting portion to a bottom surface of the circumferential groove, and the cutout may be disposed to be circumferentially spaced apart from the inner supporting portion.

Further, according to the present embodiments, the shaft coupling portion may have a seating recess where the outer supporting portion and the inner supporting portion are seated and supported.

According to the present embodiments, there may be provided a steer-by-wire steering device comprising a shaft interlocking member coupled to a steering shaft to rotate in conjunction, a rotation stopper member rotatably coupled to the steering shaft to be supported on an end portion of the shaft interlocking member and rotate in conjunction with the shaft interlocking member when the steering shaft rotates, and a housing having an arc-shaped guide recess where an end portion of the rotation stopper member is inserted and supported to restrict rotation of the steering shaft and the shaft interlocking member and the rotation stopper member when the steering shaft rotates.

Further, according to the present embodiments, the steer-by-wire steering device may further comprise an axial supporting member coupled to the steering shaft to axially support the shaft interlocking member and the rotation stopper member.

Further, according to the present embodiments, the shaft interlocking member may include a shaft coupling portion having a shaft hole to which the steering shaft is coupled and an extension supporting portion radially extending from a side of an outer circumferential surface of the shaft coupling portion to be supported by the rotation stopper member.

Further, according to the present embodiments, the rotation stopper member may include a main body having a coupling hole to which the steering shaft is coupled and a protrusion supporting portion radially extending from a side of an outer circumferential surface of the main body and axially protruding to support the extension supporting portion.

Further, according to the present embodiments, a damping member elastically supporting the extension supporting portion may be coupled to the protrusion supporting portion, and a damping recess where the damping member is supported may be formed in an inner surface of an end on two opposite sides of the guide recess.

Further, according to the present embodiments, the steer-by-wire steering device may further comprise a stopper supporting member coupled between the coupling hole of the main body and an outer circumferential surface of the steering shaft to be axially supported by the shaft coupling portion.

Further, according to the present embodiments, the stopper supporting member may be formed as a ring with a cutout in a side thereof and may have an outer circumferential groove formed in an outer circumferential surface thereof to seat an inner surface of the coupling hole.

Further, according to the present embodiments, the stopper supporting member may have a circumferential groove circumferentially formed in an outer end portion, and have an outer supporting portion formed radially outside of the circumferential groove and an inner supporting portion formed radially inside of the circumferential groove.

Further, according to the present embodiments, the inner supporting portion may have a cutout from an outer end of the inner supporting portion to a bottom surface of the circumferential groove, and the cutout may be disposed to be circumferentially spaced apart from the inner supporting portion.

Further, according to the present embodiments, the shaft coupling portion may have a seating recess where the outer supporting portion and the inner supporting portion are seated and supported.

According to some embodiments of the present disclosure, a steer-by-wire steering device may enhance the driver's sense of steering and steering stability by stopping a steering wheel from further rotating over an allowable rotation range when the rotation of the steering wheel reaches a maximum point.

### BRIEF DESCRIPTION OF DRAWINGS

The above and other objects, features, and advantages of the disclosure will be more clearly understood from the following detailed description, taken in conjunction with the accompanying drawings, in which:

FIG. 1 is a schematic diagram for schematically illustrating a steer-by-wire steering system according to an embodiment of the present disclosure;

FIG. 2 is a perspective view illustrating a portion of a steer-by-wire steering device according to an embodiment of the present disclosure;

FIGS. 3 and 4 are exploded perspective views illustrating a portion of a steer-by-wire steering device according to an embodiment of the present disclosure;

FIG. 5 is a cross-sectional view illustrating a portion of a steer-by-wire steering device according to an embodiment of the present disclosure;

FIG. 6 is an exploded perspective view illustrating a portion of a steer-by-wire steering device according to an embodiment of the present disclosure;

FIG. 7 is a cross-sectional view illustrating a portion of a steer-by-wire steering device according to an embodiment of the present disclosure;

FIG. 8 is a perspective view illustrating a portion of a steer-by-wire steering device according to an embodiment of the present disclosure;

FIG. 9 is a cross-sectional view illustrating a portion of a steer-by-wire steering device according to an embodiment of the present disclosure;

FIG. 10 is a front view illustrating a process of restricting rotation in the steer-by-wire steering device of FIGS. 1 to 9;

FIGS. 11 and 12 are exploded perspective views illustrating a portion of a steer-by-wire steering device according to another embodiment of the present disclosure;

FIG. 13 is a cross-sectional view illustrating a portion of a steer-by-wire steering device according to another embodiment of the present disclosure; and

FIG. 14 is a front view illustrating a process of restricting rotation in the steer-by-wire steering device of FIGS. 11 to 13.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

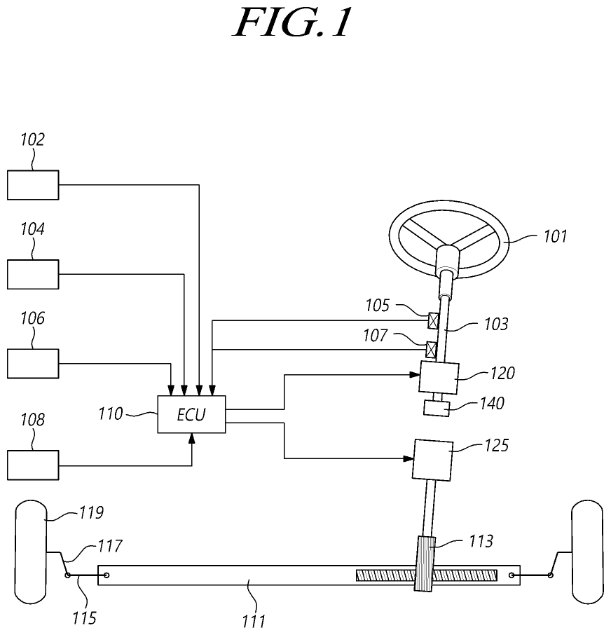

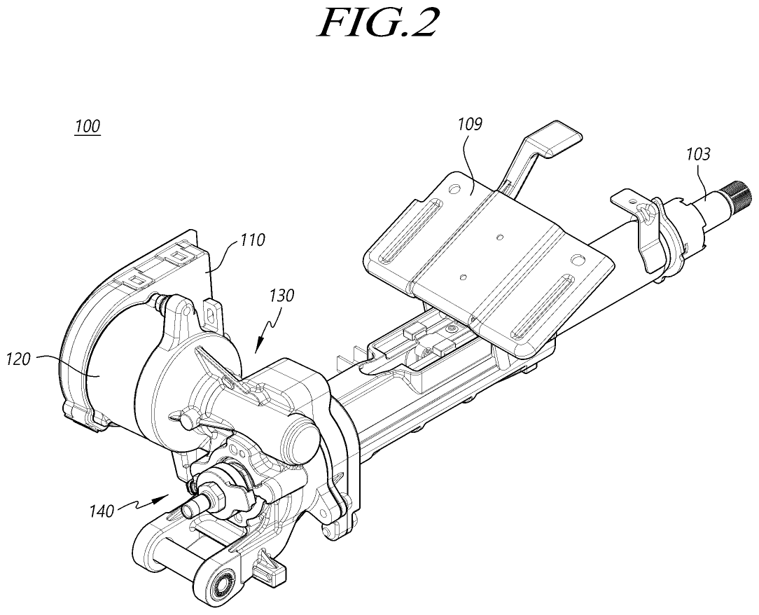

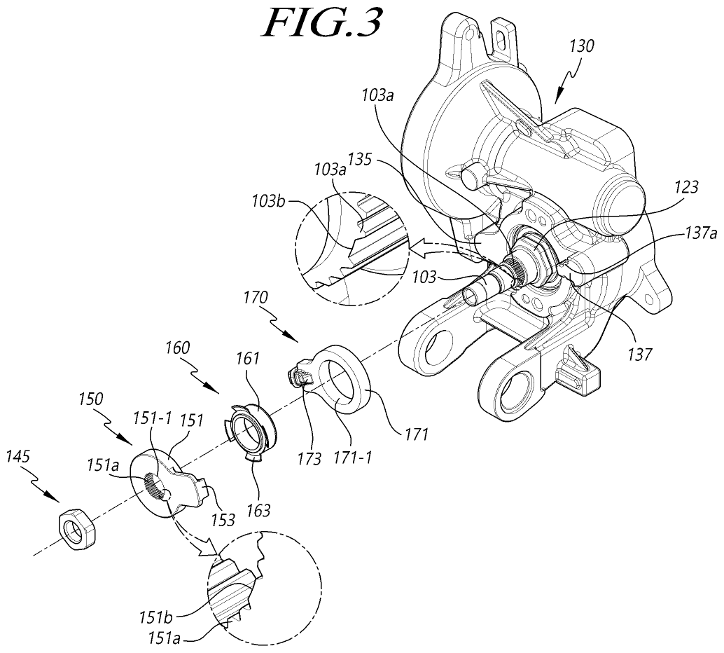

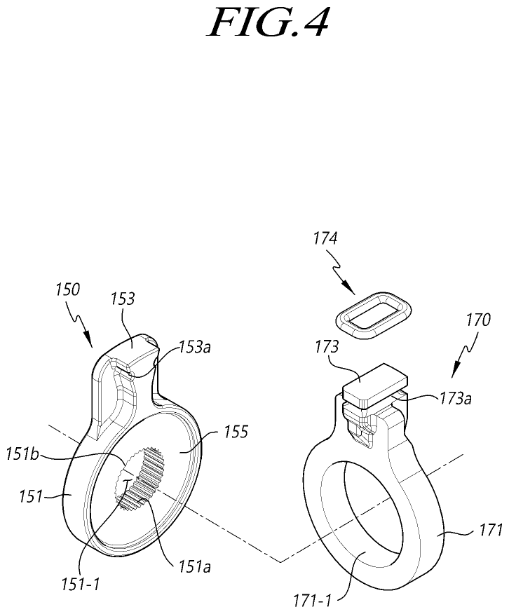

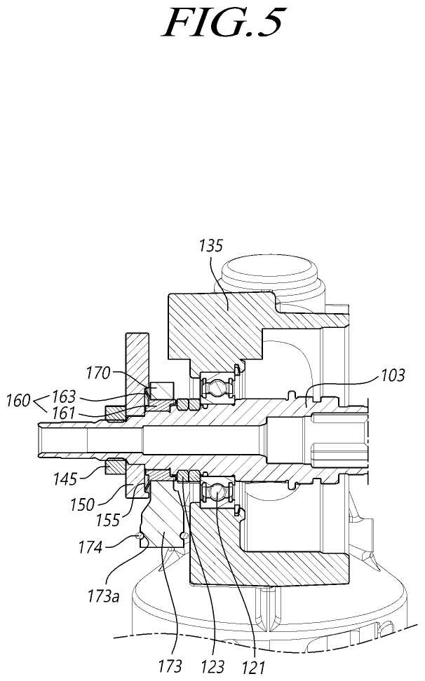

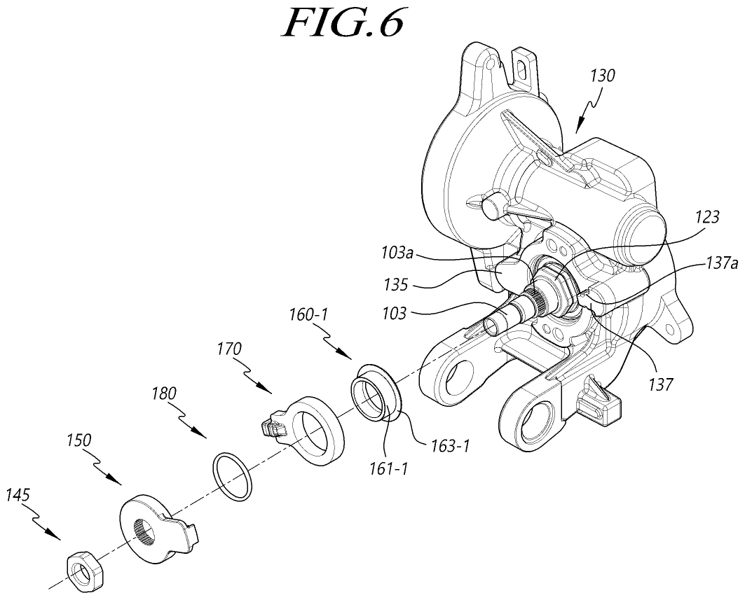

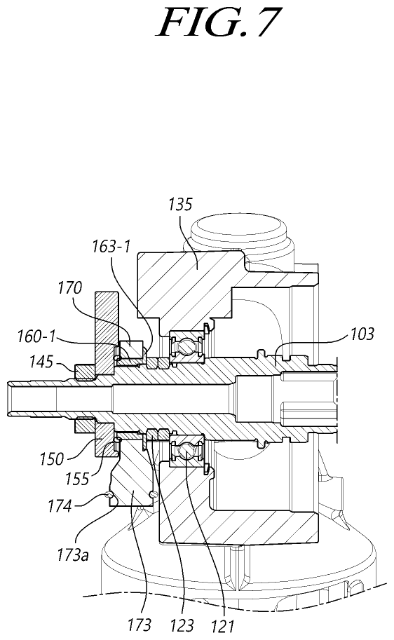

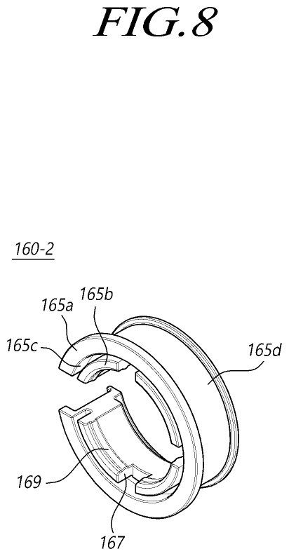

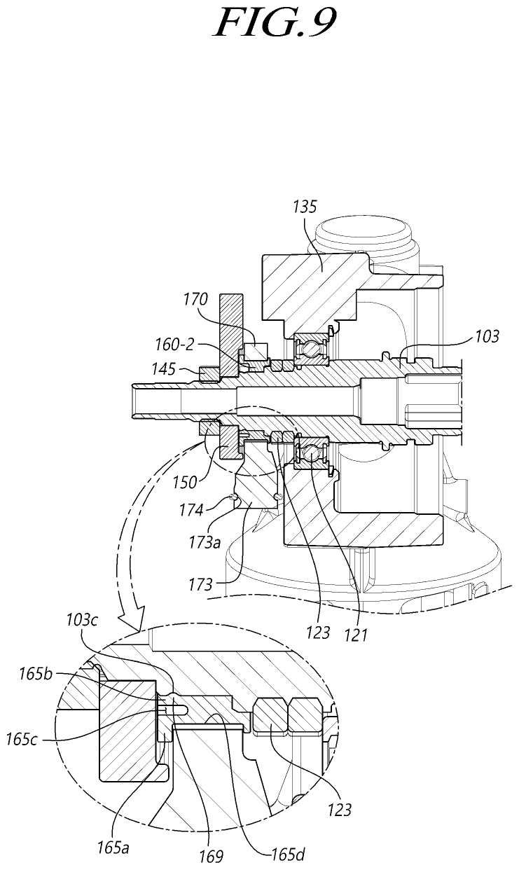

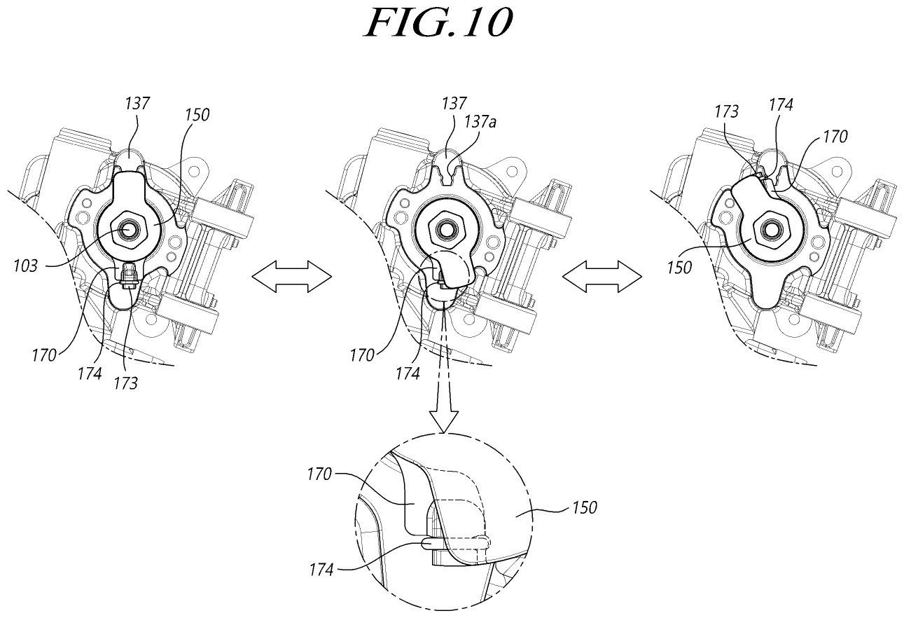

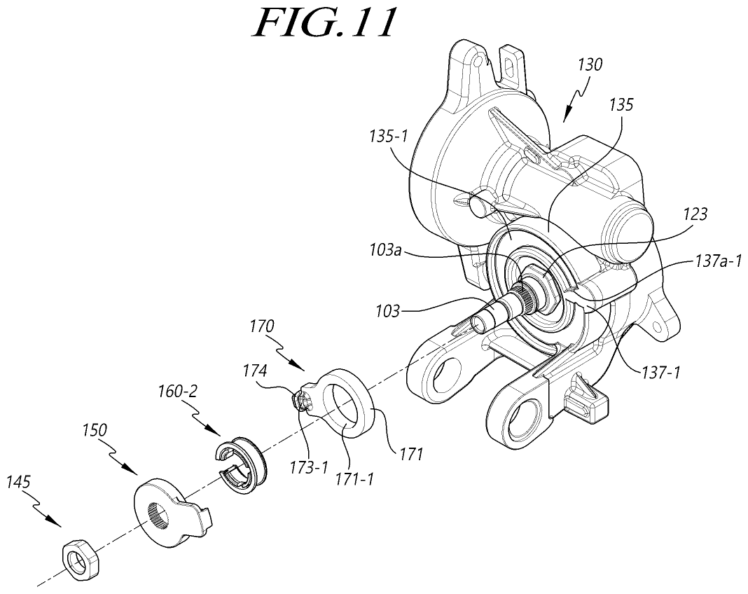

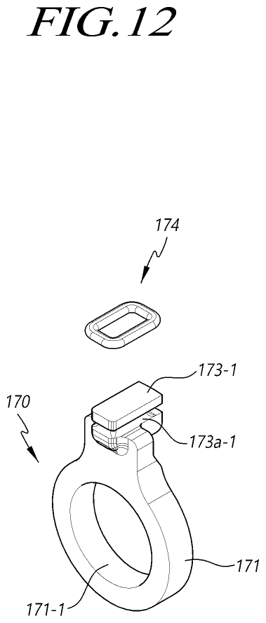

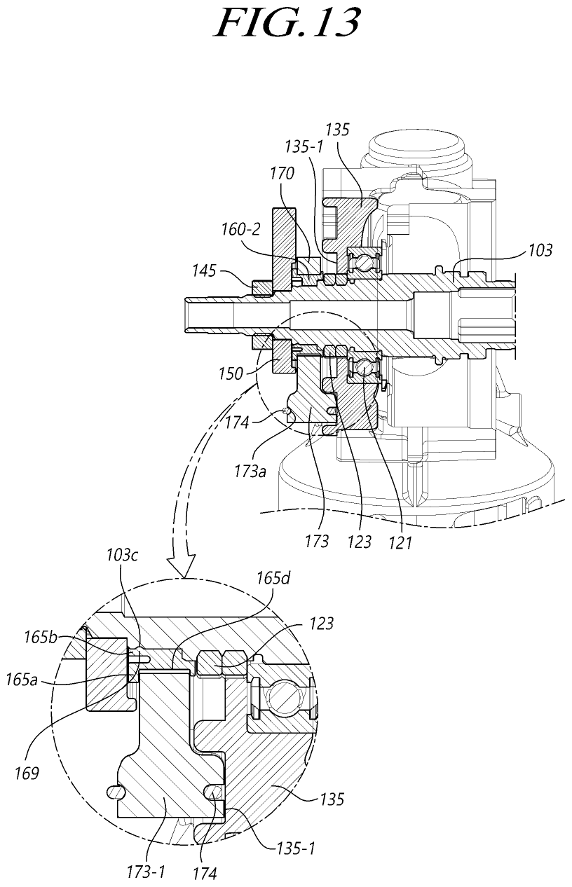

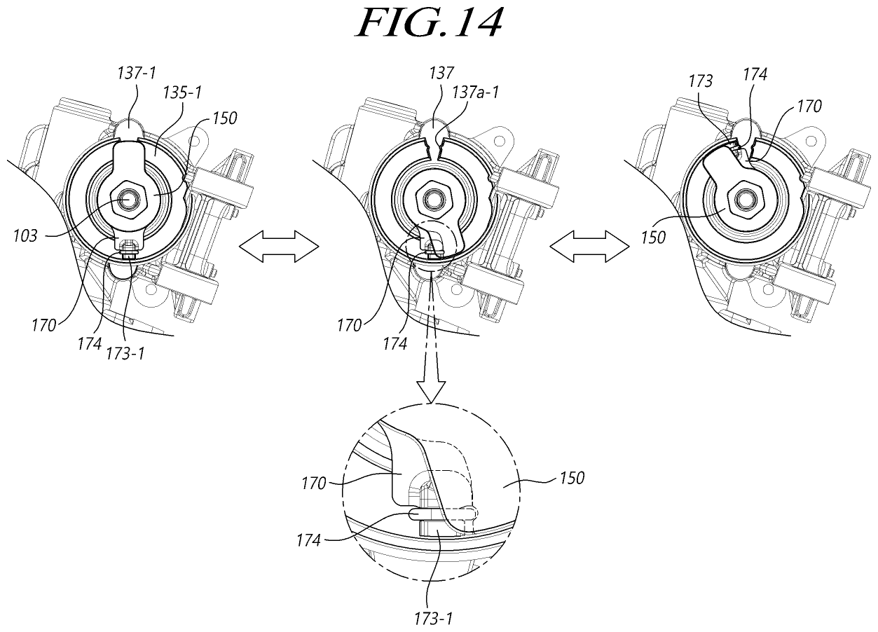

FIG. 1 is a schematic diagram for illustrating a steer-by-wire steering system according to an embodiment of the present disclosure. FIG. 2 is a perspective view illustrating a portion of a steer-by-wire steering device according to an embodiment of the present disclosure. FIGS. 3 and 4 are exploded perspective views illustrating a portion of a steer-by-wire steering device according to an embodiment of the present disclosure. FIG. 5 is a cross-sectional view illustrating a portion of a steer-by-wire steering device according to an embodiment of the present disclosure. FIG. 6 is an exploded perspective view illustrating a portion of a steer-by-wire steering device according to an embodiment of the present disclosure. FIG. 7 is a cross-sectional view illustrating a portion of a steer-by-wire steering device according to an embodiment of the present disclosure. FIG. 8 is a perspective view illustrating a portion of a steer-by-wire steering device according to an embodiment of present disclosure. FIG. 9 is a cross-sectional view illustrating a portion of a steer-by-wire steering device according to an embodiment of the present disclosure. FIG. 10 is a front view illustrating a process of restricting rotation in the steer-by-wire steering device of FIGS. 1 to 9. FIGS. 11 and 12 are exploded perspective views illustrating a portion of a steer-by-wire steering device according to another embodiment of the present disclosure. FIG. 13 is a cross-sectional view illustrating a portion of a steer-by-wire steering device according to another embodiment of the present disclosure. FIG. 14 is a front view illustrating a process of restricting rotation in the steer-by-wire steering device of FIGS. 11 to 13.

A steer-by-wire steering device according to an embodiment of the present disclosure may include a shaft interlocking member 150, a rotation stopper member 170, and a housing 135. The shaft interlocking member 150 may be fixedly coupled to a steering shaft 103 such that the shaft interlocking member 150 is rotatable together with the steering shaft 103. The rotation stopper member 170 may be rotatably coupled to the steering shaft 103 to be supported by or on an end portion of the shaft interlocking member 150 and be configured to rotate in conjunction with the shaft interlocking member 150 when the steering shaft 103 rotates. The housing 135 may have a stopper protrusion 137 in which an end portion of the rotation stopper member 170 is supported to restrict the rotation of the steering shaft 103, the shaft interlocking member 150 and the rotation stopper member 170 when the steering shaft 103 rotates.

First, referring to FIGS. 1 and 2, in the steer-by-wire steering system according to an embodiment of the present disclosure, an angle sensor 105 and a torque sensor 107 may be disposed in sensing relationship with the steering shaft 103. For example, the angle sensor 105 and the torque sensor 107 are coupled on one side of the steering shaft 103 connected with the steering wheel 101 and, when the driver rotates or manipulates the steering wheel 101, the angle sensor 105 and the torque sensor 107 detecting the user's manipulation or rotation send electrical signals to an electronic control unit (ECU) 110 to control or operate a steering shaft motor 120 and a pinion shaft motor 125.

The electronic control unit 110 controls the steering shaft motor 120 and the pinion shaft motor 125 based on a control signal of the ECU 110, the electrical signals transmitted from the angle sensor 105 and the torque sensor 107 and/or electrical signals transmitted from other various sensors mounted to the vehicle.

The steering shaft motor 120 is connected to a reducer 130 for reducing the number of rotations of the motor. In normal or manual driving, the steering shaft motor 120 provides a reaction or feedback force to the steering shaft 103 so that the driver may feel the steering reaction or feedback force when manipulating the steering wheel 101. In autonomous driving, steering is performed under the control of the electronic control unit 110 without the driver's manipulation or involvement.

The pinion shaft motor 125 may have or be coupled to the pinion shaft 113. The pinion shaft motor 125 may slide or linearly move the rack bar 111 connected to the pinion shaft 113 to steer the road wheels 119 on two opposite sides through the tie rods 115 and the knuckle arms 117.

In the present embodiments, FIG. 1 illustrate an example of including the angle sensor 105 and the torque sensor 107 provided on the steering shaft 103, and a vehicle velocity sensor 102, a pinion shaft rotational angle sensor 104, an ultrasonic sensor 106, and an image sensor 108 for sending sensing information related to steering to the electronic control unit 110 for convenience of description. However, one or more sensors included the steer-by-wire steering system illustrated in FIG. 1 may be omitted or replaced with other types of sensor, and a motor position sensor, various radar or lidar devices may be additionally provided.

In the steer-by-wire steering system, the steering wheel 101 and the road wheels 119 may be not mechanically connected to each other, and therefore the steer-by-wire system may require a structure for mechanically limiting a rotatable range of the steering wheel in order to mechanically stop the rotation of the steering wheel 101 at a predetermined angle when the steering wheel 101 is operated by the driver.

Therefore, the steer-by-wire system according to an embodiment of the present disclosure may comprise a rotational angle restricting member (or a stopper) 140 configured to mechanically restrict the rotational angle of the steering shaft 103 so that the rotational angle restricting member or the stopper 140 can stop the steering wheel 101 from further rotation when the rotation of the road wheel 119 reaches the maximum point (corresponding to a case when the steering wheel 101 or the wheel 119 is in a full-turn state in the conventional steering device), providing an accurate sense of the steering to the driver.

The rotational angle restricting member 140 may be provided at the lower end of the steering column 100 fixedly coupled to a part of a vehicle body by a mounting bracket 109 and, together with the steering shaft motor 120, the reducer 130, and the like, is coupled to the housing 135.

In an embodiment of the present disclosure, the reducer 130 may have a worm shaft connected to the steering shaft motor 120 to rotate and a worm wheel coupled to the steering shaft 103 to be rotated by the worm shaft, so that the rotation of the steering shaft motor 120 may be reduced by the gear ratio between the worm shaft and the worm wheel. However, the reducer 130 can be any mechanical mechanism configured to reduce an output such as a rotational speed of the steering shaft motor 120.

The rotational angle restricting member 140 includes a shaft interlocking member 150, a rotation stopper member 170, a housing 135, and an axial support member 145. The shaft interlocking member 150 may be fixedly coupled to a steering shaft 103 such that the shaft interlocking member 150 can rotate together with the steering shaft 103. The rotation stopper member 170 may be rotatably coupled to the steering shaft 103 to be supported by or on an end portion of the shaft interlocking member 150 and be configured to rotate in conjunction with the shaft interlocking member 150 when the steering shaft 103 rotates. The housing 135 may have a stopper protrusion 137 in which an end portion of the rotation stopper member 170 is supported to restrict the rotation of the steering shaft 103 and the shaft interlocking member 150 when the steering shaft 103 rotates. The axial supporting member 145 may be coupled to the steering shaft 103 to axially support the shaft interlocking member 150 and the rotation stopper member 170.

The shaft interlocking member 150, coupled to the steering shaft 103 and configured to rotate in conjunction with the steering shaft 103, includes a shaft coupling portion 151 substantially ring-shaped and having a shaft hole 151-1 to which the steering shaft 103 is coupled, and an extension supporting portion or extension support portion 153 extending radially from one side of the outer circumferential surface of the shaft coupling portion 151 and supported by the rotation stopper member 170.

A plurality of inner circumferential toothed portions 151a are formed on the inner circumferential surface of the shaft hole 151-1 and teeth of the inner circumferential toothed portions 151a of the shaft hole 151-1 are formed along the axial direction of the steering shaft 103, and outer circumferential toothed portions 103a engaged with the inner circumferential toothed portions 151a are formed on the outer circumferential surface of the steering shaft 103 inserted into and coupled to the shaft hole 151-1 and teeth of the outer circumferential toothed portions 103a of the steering shaft 103 are formed along the axial direction of the steering shaft 103.

As s illustrated in FIGS. 3 and 4, one of the inner circumferential tooth shape portion 151a and the outer circumferential tooth shape portion 103a engaged with each other may have a teeth combined portion 151b where two or more teeth are connected in the circumferential direction, and the other of the inner circumferential tooth shape portion 151a and the outer circumferential tooth shape portion 103a may have a teeth cutout portion 103b where two or more teeth are cut out, so that the shaft interlocking member 150 and the steering shaft 103 may be fixedly coupled to each other at a position where the teeth combined portion 151b and the teeth cutout portion 103b are engaged with each other.

In an embodiment illustrated in FIGS. 3 and 4, an example in which the inner circumferential tooth shape portion 151a has the teeth combined portion 151b where two or more teeth are connected in the circumferential direction and the outer circumferential tooth shape portion 103a has the teeth cutout portion 103b where two or more teeth are cut out is shown for illustration purposes only.

Since the teeth combined portion 151b may have a thick tooth, the teeth combined portion 151b may be coupled only to the teeth cutout portion 103b. By limiting the position at which the shaft interlocking member 150 and the steering shaft 103 are coupled, the shaft interlocking member 150 may be coupled in an accurate phase at the center position in which the steering wheel 101 is neutral.

The rotation stopper member 170 may include a ring-shaped main body 171 and a protrusion supporting portion or protrusion support portion 173. The main body 171 may be substantially ring-shaped and include a coupling hole 171-1 to which the steering shaft 103 is inserted and coupled. The protrusion supporting portion 173 may extend radially from one side of the outer circumferential surface of the main body 171 and axially protrude to support the extension supporting portion 153 of the shaft interlocking member 150.

The coupling hole 171-1 to which the steering shaft 103 is coupled is provided at the center of the main body 171 of the rotation stopper member 170, the protrusion supporting portion 173 is formed to extend radially from one side of the outer circumferential surface of the main body 171, and the protrusion supporting portion 173 axially protrudes so that the extending supporting portion 153 of the shaft interlocking member 150 may be rotated and supported.

In an embodiment of the present disclosure, a damping member or a damper 174 may be configured to elastically support the extension supporting portion 153 and may be coupled to the protrusion supporting portion 173, and an anti-falloff groove 173a may be formed on or in the outer circumferential surface of the protrusion supporting portion 173 such that the damping member 174 is inserted or coupled to the anti-falloff groove 173a in order not to fall off from the rotation stopper member 170.

Further, the extension supporting portion 153 of the shaft interlocking member 150 supporting and rotating the rotation stopper member 170 has a supporting recess 153a that is formed to have a width smaller than a part of the extension supporting portion 153 where the supporting recess 153a is not formed. The supporting recess 153a may have a shape of being formed by cutting two opposite sides of the extension supporting portion 153 in the circumferential direction of a surface facing the protrusion supporting portion 173. The extension supporting portion 153 may be configured to support the damping member or damper 174 when the shaft interlocking member 150 rotates, and the stopper protrusion 137 also has a supporting recess 137a to support the damping member 174.

Accordingly, as the width between two opposite sides of the extension supporting portion 153 facing the protrusion supporting portion 173 of the extension supporting portion 153 is formed to be reduced, the rotational angle by which the shaft interlocking member 150 is rotatable may increase, thereby increasing the designer's degree of freedom.

As the shaft interlocking member 150 is rotated to be supported on the damping member 174 and the extension supporting portion 153 and rotates the rotation stopper member 170 when the steering shaft 103 rotates and then the damping member 174 of the rotation stopper member 170 and the extension supporting portion 153 are supported by the stopper protrusion 137 of the housing 135, the rotation of the steering shaft 103 and the shaft interlocking member 150 and the rotation stopper member 170 is restricted and stopped.

Further, an embodiment of the present disclosure may further include a stopper supporting member or a stopper support 160 coupled between the coupling hole 171-1 of the main body 171 and the outer circumferential surface of the steering shaft 103 and axially supported by the shaft coupling portion 151 of the shaft interlocking member 150.

The stopper supporting member 160 according to an embodiment illustrated in FIGS. 3 and 5 may have an insertion portion 161 formed in a ring shape, and an inclined protrusion 163 protruding obliquely between the axial direction and the radial direction from or at an outer circumferential surface or an edge or end portion of the insertion portion 161 facing the shaft coupling portion 151.

The shaft coupling portion 151 of the shaft interlocking member 150 has a seating recess 155 axially recessed from a surface of the shaft coupling portion 151 facing the stopper supporting member 160, so that the inclined protrusion 163 and the end portion of the insertion portion 161 can be supported and seated in the seating recess 155.

Accordingly, during the assembly of the steer-by-wire device, the shaft interlocking member 150 axially supports the stopper supporting member 160 by the tightening force of an axially supporting member or a fastener 145 screwed to the steering shaft 103, and then the stopper supporting member 160 is elastically deformed in the axial direction and radial direction to support the steering shaft 103 and the rotation stopper member 170, so that the rotation stopper member 170 may be supported by the shaft interlocking member 150 at the assembled position without free rotation.

The inner end of the stopper supporting member 160 is supported and fixed in position by a lock nut 123. The lock nut 12 axially supports and fixes the bearing 121.

Further, the stopper supporting member 160-1 shown in FIGS. 6 and 7 has an end supporting portion 163-1 supporting the inner end portion of the main body 171 of the rotation stopper member 170, and a ring-shaped elastic member 180 may be coupled between the outer end portion of the stopper supporting member 160-1 and the shaft coupling portion 151 to axially support the stopper supporting member 160-1 and the main body 171. For example, the ring-shaped elastic member 180 may be an elastomer or a rubber.

In this case, the end supporting portion 163-1 is supported and fixed in position by the lock nut 123, and the elastic member 180 axially supports the rotation stopper member 170 and the stopper supporting member 160-1.

In other words, during the assembly process of the steer-by-wire steering device, the shaft interlocking member 150 axially supports the stopper supporting member 160-1 by the tightening force of the axially supporting member 145 screwed to the steering shaft, and, by this, the elastic member 180 is elastically deformed in the axial direction and radial direction to support the rotation stopper member 170 and the stopper supporting member 160-1, so that the rotation stopper member 170 may be supported by the shaft interlocking member 150 at the assembled position without free rotation.

Further, the stopper supporting member 160-2 illustrated in FIGS. 8 and 9 may be formed in a ring shape with a cutout in a side thereof and may have an outer circumferential groove 165d to receive or seat the inner surface of the coupling hole 171-1.

As one side of the stopper supporting member 160-2 is cut out, the stopper supporting member 160-2 is easily elastically deformed when assembled to the rotation stopper member 170, thereby facilitating assembly. After the assembly, the rotation stopper member 170 is seated in and inserted into the outer circumferential groove 165d, thereby maintaining the precise assembly position.

The stopper supporting member 160-2 has a circumferential groove or a side circumferential groove 165c circumferentially formed or penetrated in or into the outer end portion or side surface of the stopper supporting member 160-2. And, the stopper supporting member 160-2 has an outer supporting portion 165a formed or protruding radially on or from the outside of the circumferential groove 165c and an inner supporting portion 165b formed radially at the inside of the circumferential groove 165c.

The inner supporting portion 165b may have a cutout 167 cut from an outer end of the inner supporting portion 165b to the bottom surface of the circumferential groove 165c. And, the plurality of cutouts 167 may be disposed to be circumferentially spaced apart from each other.

Accordingly, the stopper supporting member 160-2 can be configured to be elastically deformable in both the axial direction and the radial direction to support the rotation stopper member 170, and therefore the rotation stopper member 170 may be supported and rotated by the shaft interlocking member 150 at the assembled position without free rotation.

Further, a supporting protrusion 169 radially protrudes from the inner circumferential surface of the inner supporting portion 165b, and a ring-shaped fixing groove 103c is formed on the outer circumferential surface of the steering shaft 103 so that the supporting protrusion 169 of the inner supporting portion 165b can be inserted into the fixing groove 103c of the steering shaft 103 to be coupled to each other.

Accordingly, the structure and assembly of the stopper supporting member 160-2 and the steering shaft 103 may reduce an axial gap of some components of the steer-by-wire steering device as well as circumferential friction between certain components of the steer-by-wire steering device.

The shaft coupling portion 151 has a seating recess 155 to seat and support the outer supporting portion 165a and the inner supporting portion 165b, so that the shaft interlocking member 150 can axially support the stopper supporting member 160-2 by the tightening force of the axially supporting member 145.

Referring to FIG. 10, an operating mechanism of the steer-by-wire steering device according to an embodiment of the present disclosure is described as follows.

FIG. 10 sequentially illustrates the neutral center position of the steering wheel through the times when rotation in one direction starts and then ends from the left to right drawing.

The drawing on the left of FIG. 10 illustrates a state in which the steering wheel is positioned at the neutral center position. If the shaft interlocking member 150 rotates clockwise (for example, about 160° to 170° from the neutral center) according to the clockwise rotation of the steering shaft 103, the shaft interlocking member 150 contacts the damping member or damper 174 of the rotation stopper member 170 as shown in the center drawing of FIG. 10.

Thereafter, if the shaft interlocking member 150 further rotates clockwise (for instance, about 320° to 340° from the neutral center) while supporting and rotating the rotation stopper member 170 in a clockwise direction, the rotation of the damping member 174 of the rotation stopper member 170 is blocked by being supported by the stopper protrusion 137 and the supporting recess 137a, so that the driver can feel or detect the clockwise full turn of the steering wheel.

Further, referring to FIGS. 11 to 14 together with FIGS. 1 to 10, a steer-by-wire steering device according to an embodiment of the present disclosure may include a shaft interlocking member 150, a rotation stopper member 170, and a housing 135. The shaft interlocking member 150 may be coupled to the steering shaft 103 so that the shaft interlocking member 150 can rotate with the steering shaft 103. The rotation stopper member 170 may be rotatably coupled to the steering shaft 103 to be supported on or by an end portion of the shaft interlocking member 150 and may be configured to rotate in conjunction with the shaft interlocking member 150 when the steering shaft 103 rotates. The housing 135 may have an arc-shaped guide recess 135-1 in which an end portion of the rotation stopper member 170 is inserted and supported to restrict rotation of the steering shaft 103, the shaft interlocking member 150 and the rotation stopper member 170 when the steering shaft 103 rotates.

The guide recess 135-1 is formed to be recessed in an arc shape from the outer surface of the housing 135, and two opposite ends of the guide recess 135-1 are connected by a stopper barrier rib 137-1.

Further, the steer-by-wire steering device according to an embodiment of the present disclosure may further include an axially supporting member or support 145 coupled to the steering shaft 103 to axially support the shaft interlocking member 150 and the rotation stopper member 170.

The shaft interlocking member 150 may include a ring-shaped shaft coupling portion 151 and an extension supporting portion 153. The shaft coupling portion 151 may have a shaft hole 151-1 to which the steering shaft 103 is inserted and coupled. The extension supporting portion 153 extends radially from one side of the outer circumferential surface of the shaft coupling portion 151 and is supported by the rotation stopper member 170.

The axially supporting member 145 and the shaft interlocking member 150 illustrated in FIGS. 11 to 14 are the same as or similar to those illustrated in FIGS. 1 to 10.

A plurality of inner circumferential toothed portions 151a are formed on the inner circumferential surface of the shaft hole 151-1 and teeth of the inner circumferential toothed portions 151a of the shaft hole 151-1 are formed along the axial direction of the steering shaft 103, and outer circumferential toothed portions 103a engaged with the inner circumferential tooth portions 151a are formed on the outer circumferential surface of the steering shaft 103 inserted into and coupled to the shaft hole 151-1 and teeth of the outer circumferential toothed portions 103a of the steering shaft 103 are formed along the axial direction of the steering shaft 103.

As described above, one of the inner circumferential tooth shape portion 151a and the outer circumferential tooth shape portion 103a engaged with each other may have a teeth combined portion 151b where two or more teeth are connected in the circumferential direction, and the other of the inner circumferential tooth shape portion 151a and the outer circumferential tooth shape portion 103a may have a teeth cutout portion 103b where two or more teeth are cut out, so that the shaft interlocking member 150 and the steering shaft 103 may be fixedly coupled to each other at a position where the teeth combined portion 151b and the teeth cutout portion 103b are engaged with each other.

The rotation stopper member 170 may include a ring-shaped main body 171 and a protrusion supporting portion 173-1. The main body 171 may be substantially ring-shaped and include a coupling hole 171-1 to which the steering shaft 103 is inserted and coupled. The protrusion supporting portion 173-1 may extend radially from one side of the outer circumferential surface of the main body 171 and axially protrude to support the extension supporting portion 153 of the shaft interlocking member 150.

The coupling hole 171-1 to which the steering shaft 103 is coupled is provided at the center of the main body 171, and the protrusion supporting portion 173-1 is formed to extend radially from one side of the outer circumferential surface of the main body 171 of the rotation stopper member 170, and the protrusion supporting portion 173-1 axially protrudes so that the extending supporting portion 153 of the shaft interlocking member 150 may be rotated and supported.

The protrusion supporting portion 173-1 according to an embodiment illustrated in FIGS. 11 to 14 may be formed to axially protrude further toward the housing 135 than the protrusion supporting portion 173 according to another embodiment illustrated in FIGS. 1 to 13.

Further, a damping member or damper 174 configured to elastically supporting the extension supporting portion 153 is inserted and coupled to the anti-falloff groove 173a-1 in the protrusion supporting portion 173-1.

Thus, if the shaft interlocking member 150 is rotated to be supported on the damping member 174 and the extension supporting portion 153 and rotates the rotation stopper member 170 when the steering shaft 103 rotates, the protrusion supporting portion 173-1 is rotated while being guided along the guide recess 135-1 of the housing 135 and is supported by the stopper barrier rib 137-1 at the two opposite ends of the arc of the guide recess 135-1 to restrict and stop the rotation of the steering shaft 103, the shaft interlocking member 150 and the rotation stopper member 170.

The stopper barrier rib or protrusion 137-1 connecting the two opposite ends of the arc of the guide recess 135-1 may have a supporting recess 137a-1 where the damping member 174 is supported.

Further, the embodiment illustrated in FIGS. 11 to 14 may further include a stopper supporting member or stopper support 160-2 coupled between the coupling hole 171-1 of the main body 171 and the outer circumferential surface of the steering shaft 103 and axially supported by the shaft coupling portion 151 of the shaft interlocking member 150.

The stopper supporting member 160-2 may be formed in a ring shape with a cutout in a side thereof and may have an outer circumferential groove 165d to receive or seat the inner surface of the coupling hole 171-1.

As one side of the stopper supporting member 160-2 is cut out, the stopper supporting member 160-2 is elastically deformable when assembled to the rotation stopper member 170, thereby facilitating assembly. After the assembly, the rotation stopper member 170 is seated in the outer circumferential groove 165d, thereby maintaining the precise assembly position.

The stopper supporting member 160-2 has a circumferential groove or side circumferential groove 165c circumferentially formed or penetrated in or into the outer end portion or side surface of the stopper supporting member 160-2. And, the stopper supporting member 160-2 has an outer supporting portion 165a formed or protruding radially on or from the outside of the circumferential groove 165c and an inner supporting portion 165b formed radially at the inside of the circumferential groove 165c.

The inner supporting portion 165b may have a cutout 167 cut from an outer end of the inner supporting portion 165b to the bottom surface of the circumferential groove 165c. And, the plurality of cutouts 167 may be disposed to be circumferentially spaced apart from each other.

Accordingly, the stopper supporting member 160-2 can be configured to be elastically deformable in both the axial direction and the radial direction to support the rotation stopper member 170, and therefore the rotation stopper member 170 may be supported by the shaft interlocking member 150 at the assembled position without free rotation.

Further, a supporting protrusion 169 radially protrudes from the inner circumferential surface of the inner supporting portion 165b, and a ring-shaped fixing groove 103c is formed on the outer circumferential surface of the steering shaft 103 so that the supporting protrusion 169 of the inner supporting portion 165b can be inserted into the fixing groove 103c of the steering shaft 103 to be coupled to each other.

Accordingly, the structure and assembly of the stopper supporting member 160-2 and the steering shaft 103 may reduce an axial gap of some components of the steer-by-wire steering device as well as circumferential friction between certain components of the steer-by-wire steering device.

The shaft coupling portion 151 has a seating recess 155 to seat and support the outer supporting portion 165a and the inner supporting portion 165b, so that the shaft interlocking member 150 can axially support the stopper supporting member 160-2 by the tightening force of the axially supporting member 145.

The operating mechanism of the steer-by-wire steering device according to the embodiment illustrated in FIGS. 11 to 13 is described below with reference to FIG. 14.

FIG. 14 sequentially illustrates the neutral center position of the steering wheel through the times when rotation in one direction starts and then ends from the left to right drawing.

The drawing on the left of FIG. 14 illustrates a state in which the steering wheel is positioned at the neutral center position. If the shaft interlocking member 150 rotates clockwise (for example, about 160° to 170° from the neutral center position) according to the clockwise rotation of the steering shaft 103, the shaft interlocking member 150 contacts the damping member or damper 174 of the rotation stopper member 170 as shown in the center drawing of FIG. 14.

Thereafter, if the shaft interlocking member 150 further rotates clockwise (for instance, about 320° to 340° from the neutral center position) while supporting and rotating the rotation stopper member 170 in a clockwise direction, the rotation of the damping member 174 is blocked by being supported by the stopper barrier rib 137-1 and the supporting recess 137a-1, so that the driver can feel or detect the clockwise full turn of the steering wheel.

Although one shaft interlocking member 150 and one rotation stopper member 170 are provided in exemplary embodiments of the present disclosure, it should be noted that the numbers and positions in the circumferential direction may be varied depending on the designed rotational angle value of the steering shaft 103.

As described above, the steer-by-wire steering device according to some embodiments of the present disclosure may stop the steering wheel from further rotating when the wheel rotation reaches a maximum point in order to enhance the driver's sense of steering and steering stability.

The above-described embodiments are merely examples, and it will be appreciated by one of ordinary skill in the art various changes may be made thereto without departing from the scope of the disclosure. Accordingly, the embodiments set forth herein are provided for illustrative purposes, but not to limit the scope of the disclosure, and should be appreciated that the scope of the disclosure is not limited by the embodiments. The scope of the disclosure should be construed by the following claims, and all technical spirits within equivalents thereof should be interpreted to belong to the scope of the disclosure.

What is claimed is:

1. A steer-by-wire steering device, comprising:
a shaft interlocking member fixed to a steering shaft so that the shaft interlocking member is rotated together with the steering shaft, the shaft interlocking member radially extending from the steering shaft;
a rotation stopper member rotatably arranged around the steering shaft and extending in a radial direction of the steering shaft, the rotation stopper member configured to be rotatable together with the shaft interlocking member by being supported by an end portion of the shaft interlocking member according to rotation of the steering shaft; and
a housing having a stopper protrusion protruding from a surface of the housing to block rotation of the rotation stopper member when an end portion of the rotation stopper member contacts the stopper protrusion of the housing by rotation of the shaft interlocking member.

2. The steer-by-wire steering device of claim 1, further comprising an axial support coupled to the steering shaft to axially support the shaft interlocking member and the rotation stopper member.

3. The steer-by-wire steering device of claim 1, wherein the shaft interlocking member includes:
a shaft coupling portion having a shaft hole to which the steering shaft is fixedly coupled; and
an extension support portion radially extending from the shaft coupling portion to support the rotation stopper member so that the rotation stopper member is rotated by the extension support portion of the shaft interlocking member when the extension support portion of the shaft interlocking member contacts the rotation stopper member.

4. The steer-by-wire steering device of claim 3, wherein the rotation stopper member includes:
a main body having a coupling hole in which the steering shaft is rotatably inserted; and
a protrusion support portion radially extending from the main body and axially protruding to be supported by the extension support portion of the shaft interlocking member when the extension support portion of the shaft interlocking member contacts the protrusion support portion of the rotation stopper member by the rotation of the shaft interlocking member.

5. The steer-by-wire steering device of claim 4, further comprising a damper coupled to the protrusion support portion of the rotation stopper member to elastically support the extension support portion of the shaft interlocking member.

6. The steer-by-wire steering device of claim 4, further comprising a stopper support coupled between an inner surface of the coupling hole of the main body of the rotation stopper member and an outer circumferential surface of the steering shaft such that the stopper support is axially supported by the shaft coupling portion of the shaft interlocking member.

7. The steer-by-wire steering device of claim 6, wherein the stopper support is substantially ring-shaped and has a cutout at a side of the stopper support and an outer circumferential groove formed on an outer circumferential surface of the stopper support to receive the inner surface of the coupling hole of the main body of the rotation stopper member.

8. The steer-by-wire steering device of claim 7, wherein the stopper support has a side circumferential groove circumferentially formed on the side of the stopper support, an outer support portion protruding radially and outwardly away from the side circumferential groove, and an inner support portion protruding radially and inwardly away from the circumferential groove.

9. The steer-by-wire steering device of claim 8, wherein the inner support portion of the stopper support has a cutout connected to the side circumferential groove of the stopper support.

10. The steer-by-wire steering device of claim 8, wherein the shaft coupling portion has a seating recess in which the outer supporting portion and the inner supporting portion of the stopper support are disposed.

11. A steer-by-wire steering device, comprising:
a shaft interlocking member fixed to a steering shaft so that the shaft interlocking member is rotated together with the steering shaft, the shaft interlocking member radially extending from the steering shaft;
a rotation stopper member rotatably arranged around the steering shaft and extending in a radial direction of the steering shaft, the rotation stopper member configured to be rotatable together with the shaft interlocking member by being supported by an end portion of the shaft interlocking member according to rotation of the steering shaft; and
a housing having an arc-shaped guide recess in which an end portion of the rotation stopper member is rotatably inserted wherein ends of the arc-shaped guide recess are configured to block rotation of the end portion of the rotation stopper member when the end portion of the rotation stopper member contacts one of the ends of the arc-shaped guide recess by the rotation of the shaft interlocking member.

12. The steer-by-wire steering device of claim 11, further comprising an axial support coupled to the steering shaft to axially support the shaft interlocking member and the rotation stopper member.

13. The steer-by-wire steering device of claim 11, wherein the shaft interlocking member includes:
a shaft coupling portion having a shaft hole to which the steering shaft is fixedly coupled; and
an extension support portion radially extending from the shaft coupling portion to support the rotation stopper member so that the rotation stopper member is rotated by the extension support portion of the shaft interlocking member when the extension support portion of the shaft interlocking member contacts the rotation stopper member.

14. The steer-by-wire steering device of claim 13, wherein the rotation stopper member includes:
a main body having a coupling hole in which the steering shaft is rotatably inserted; and
a protrusion support portion radially extending from the main body and axially protruding to be supported by the extension support portion of the shaft interlocking member when the extension support portion of the shaft interlocking member contacts the protrusion support portion of the rotation stopper member by the rotation of the shaft interlocking member.

15. The steer-by-wire steering device of claim 14, further comprising a damper coupled to the protrusion support portion of the rotation stopper member to elastically support the extension support portion of the shaft interlocking member, a damping recess where the damper is supported is formed in an inner surface of the ends of the arc-shaped guide recess.

16. The steer-by-wire steering device of claim 14, further comprising a stopper support coupled between an inner surface of the coupling hole of the main body of the rotation stopper member and an outer circumferential surface of the steering shaft such that the stopper support is axially supported by the shaft coupling portion of the shaft interlocking member.

17. The steer-by-wire steering device of claim 16, wherein the stopper support is substantially ring-shaped and has a cutout at a side of the stopper support and an outer circumferential groove formed on an outer circumferential surface of the stopper support to receive the inner surface of the coupling hole of the main body of the rotation stopper member.

18. The steer-by-wire steering device of claim 17, wherein the stopper support has a side circumferential groove circumferentially formed on the side of the stopper support, an outer support portion protruding radially and outwardly away from the side circumferential groove and an inner supporting portion protruding radially and inwardly away from side circumferential groove.

19. The steer-by-wire steering device of claim 18, wherein the inner support portion of the stopper support has a cutout connected to the side circumferential groove of the stopper support.

20. The steer-by-wire steering device of claim 18, wherein the shaft coupling portion has a seating recess in which the outer supporting portion and the inner supporting portion of the stopper support are disposed.
